(19) United States
(12) Patent Application Publication
(10) Pub. No.: US 2006/0076412 A1
(43) Pub. Date: Apr. 13, 2006

(54) Card reading apparatus

(76) Inventors: Yen-Hung Chen, Hsintien City (TW); Chiu-Kuei Chen, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,528

(22) Filed: Oct. 13, 2004

(51) Int. Cl. G06K 7/06

(52) U.S. Cl. 235/441

(57) ABSTRACT

A card reading apparatus for insertion of an electronic card therein has an insulating housing and a card ejection mechanism. The insulating housing comprises a sliding space formed therein. The card ejection mechanism has a sliding assembly. The sliding assembly is slidably arranged in the sliding space and has a connection plate, a first sliding member and a second sliding member. The first sliding member and the second sliding member are respectively hooked on two opposite edges of the connection plate and form a card insertion space therebetween. The electronic card is inserted into the card insertion space.

### BACKGROUND OF THE INVENTION

1. Field of the Invention

The present invention relates to a card reading apparatus, and more particularly, to a card reading apparatus in which an ejection action of an electronic card inserted therein is completed by pushing the electronic card.

2. Background of the Invention

It is well known that electronic cards are commonly applied to various electronic products, such as cellular phones, personal digital assistants, or digital cameras. Every electronic product has a card reading apparatus for insertion of an electronic card therein, such that the electronic card electrically contacts a corresponding set of terminals of the card reading apparatus. The card reading apparatus also provides a card ejection function for easy removal of the electronic card.

A conventional card reading apparatus includes an insulating housing and a card ejection mechanism. The card ejection mechanism includes a sliding member, a guiding rod, and a resilient member. The sliding member is slidably arranged in the insulating housing and has a track slot. The guiding rod has an end pivotly connecting in the insulating housing and another end movably arranged in the track slot. The resilient member is between the sliding member and the insulating housing.

When an electronic card is inserted into the insulating housing, only one corner of a front edge of the electronic card pushes the sliding member, which causes an imbalance between two corners of the front edge of the electronic card and an unsmooth insertion of the electronic card. When the electronic card is pushed into the insulating housing again, the resilient member generates elasticity to pushes the sliding member. However, only the one corner of the front edge of the electronic card is pushed by the sliding member to eject the electronic card out of the insulating housing, which causes an imbalance between the two corners of the front edge of the electronic card and an unsmooth ejection of the electronic card.

To solve the above problems, another conventional card reading apparatus has an U-shaped sliding member. However, the sliding member is easily deformed during assembly and use, which causes instability of the actions of the guiding rod and the card ejection mechanism and affects the insertion and the ejection of the electronic card.

Accordingly, as discussed above, the conventional card reading apparatus still has some drawbacks that could be improved. The present invention aims to resolve the drawbacks in the prior art.

### SUMMARY OF INVENTION

The primary object of the invention is therefore to specify a card reading apparatus having a card ejection mechanism with a significantly more stable action to ensure that an electronic card has a much smoother action during insertion and ejection from the card reading apparatus.

According to the invention, the object is achieved via a card reading apparatus for insertion of an electronic card therein. The card reading apparatus comprises an insulating housing and a card ejection mechanism. The insulating housing comprises a sliding space formed therein. The card ejection mechanism includes a sliding assembly. The sliding assembly is slidably arranged in the sliding space and includes a connection plate, a first sliding member and a second sliding member. The first sliding member and the second sliding member are respectively hooked on two opposite edges of the connection plate and form a card insertion space therebetween. The electronic card is inserted into the card insertion space.

The first sliding member and the second sliding member are respectively hooked on two opposite edges of the connection plate; the structure of the sliding assembly is consequently much more balanced, and the action of the card ejection mechanism is much more stable. Furthermore, when the electronic card is inserted into or ejected from the insulating housing, the acting force between the sliding assembly and the electronic card is much more balanced, so that the insertion or the ejection of the electronic card is much smoother.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded perspective view of a card reading apparatus of the present invention;

FIG. 2 is an exploded perspective view of an insulating housing and a card ejection mechanism of a card reading apparatus of the present invention;

FIG. 3 is an exploded partial perspective view of an insulating housing and a sliding assembly of a card ejection mechanism of a card reading apparatus of the present invention;

FIG. 4 is another exploded partial perspective view of an insulating housing and a sliding assembly of a card ejection mechanism of a card reading apparatus of the present invention;

FIG. 5 is a perspective assembly view of an insulating housing, a sliding assembly of a card ejection mechanism, a first set of terminals, and a second set of terminals of a card reading apparatus of the present invention;

FIG. 6 is another perspective assembly view of an insulating housing, a sliding assembly of a card ejection mechanism, a first set of terminals, and a second set of terminals of a card reading apparatus of the present invention; and

FIG. 7 is an exploded perspective view of a card reading apparatus of another embodiment of the present invention.

### DETAILED DESCRIPTION OF THE EMBODIMENTS

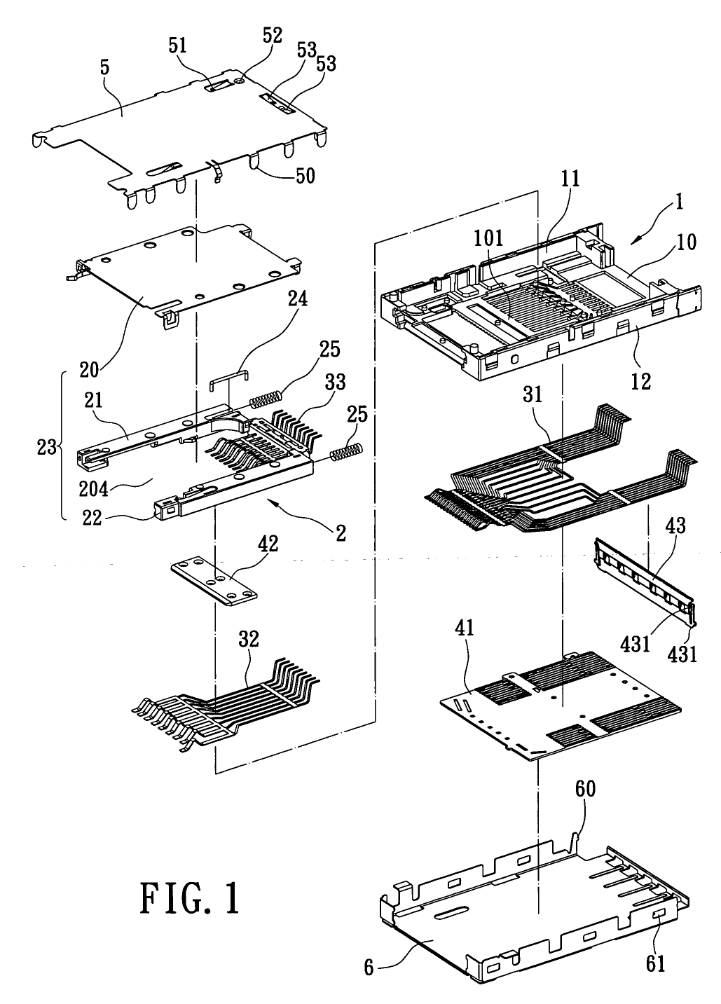

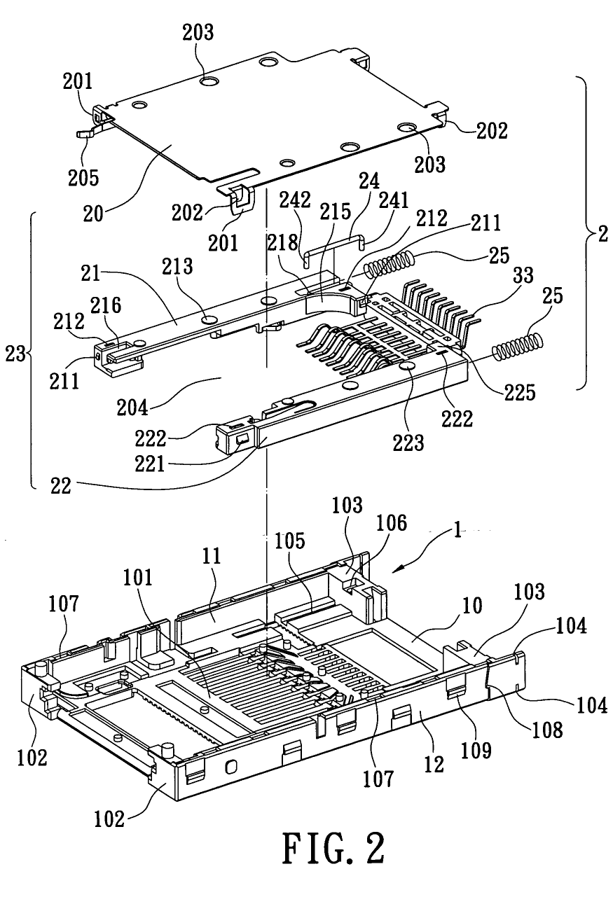

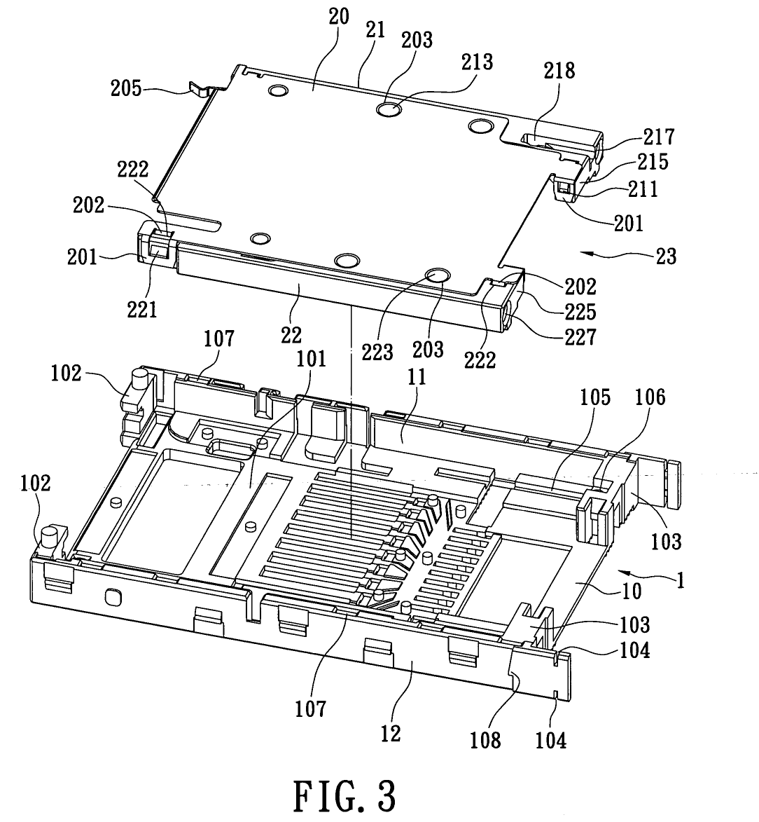

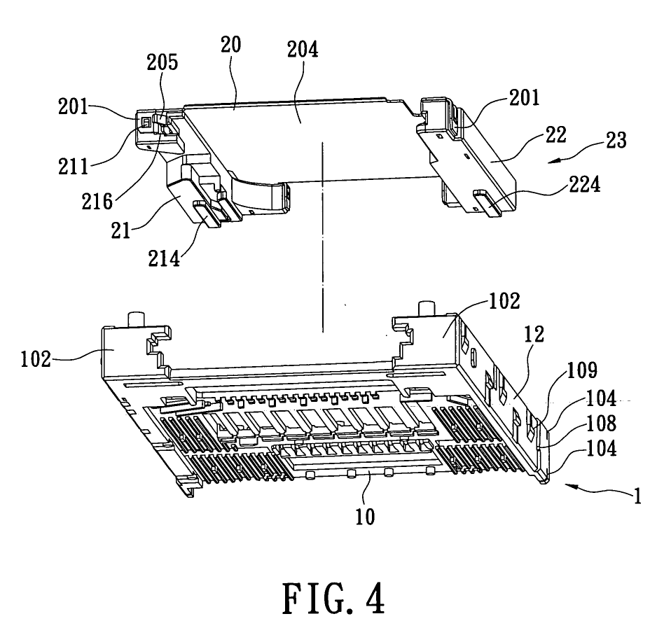

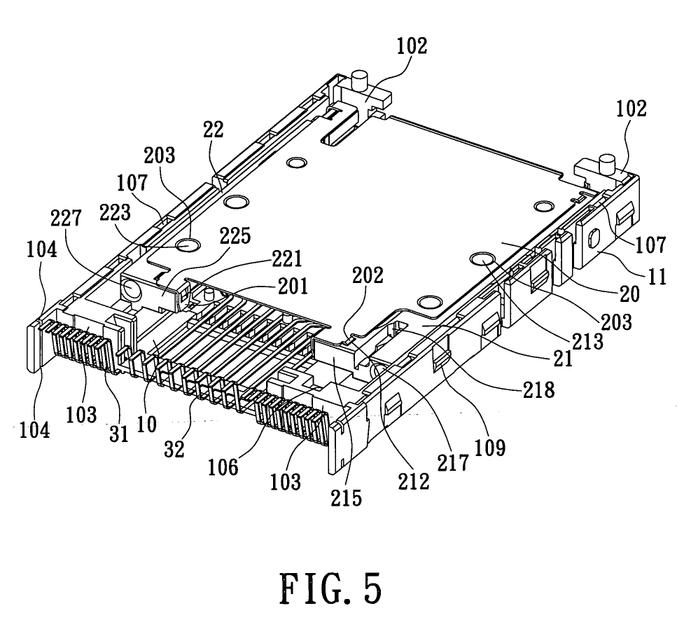

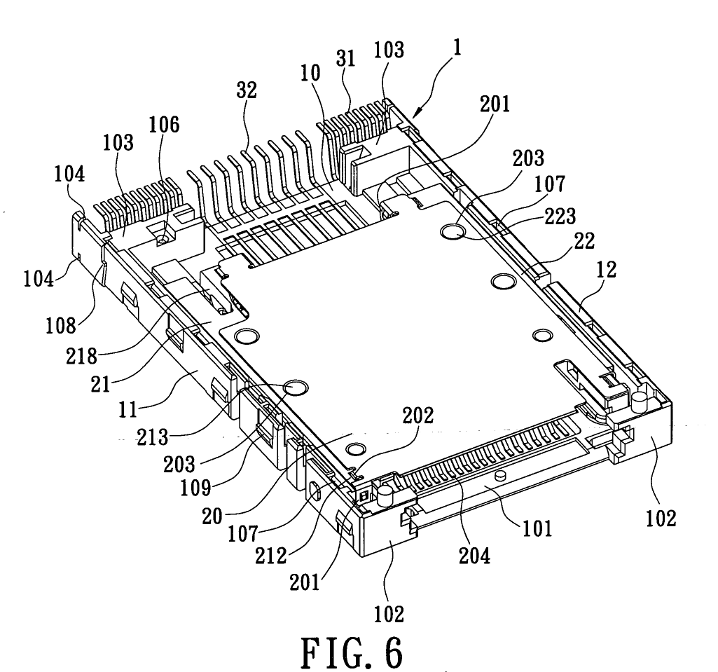

Referring to FIG. 1 to FIG. 6, the present invention provides a card reading apparatus for insertion of an electronic card (not shown) therein. The card reading apparatus comprises an insulating housing 1 and a card ejection mechanism 2. In this embodiment, the card reading apparatus also comprises a first set of terminals 31, a second set of terminals 32, a third set of terminals 33, a first pressing plate 41, a second pressing plate 42, a rear pressing plate 43, a cover 5, and a shielding casing 6.

The insulating housing 1 comprises a sliding space 101 formed therein. In this embodiment, the insulating housing 1 has a base plate 10, a first sidewall 11, and a second sidewall 12. The first sidewall 11 and the second sidewall 12 respectively connect on two opposite edges of the base plate 10 to form the sliding space 101 of the insulating housing 1 therebetween. The base plate 10 has two guiding slots 105 respectively disposed at the two opposite edges thereof. The first sidewall 11 and the second sidewall 12 respectively have a front baffle 102 at a front end thereof. The first sidewall 11 and the second sidewall 12 respectively have a rear baffle 103 at a rear end thereof. Each of the first sidewall 11 and the second sidewall 12 has two holding slots 104 disposed at the rear ends thereof.

The card ejection mechanism 2 includes a sliding assembly 23, a guiding rod 24, and two resilient members 25. The sliding assembly 23 is slidably arranged in the sliding space 101 of the insulating housing 1. The sliding assembly 23 includes a connection plate 20, a first sliding member 21 and a second sliding member 22. The connection plate 20 has four hooking ears 201 respectively disposed at a front end and a rear end of two opposite edges thereof. The first sliding member 21 has two holding blocks 211 respectively disposed at a front end and a rear end thereof, and the second sliding member 22 has two holding blocks 221 respectively disposed at a front end and a rear end thereof. The holding blocks 211, 221 are respectively hooked in the hooking ears 201. Moreover, the connection plate 20 has four insertion tabs 202 respectively disposed at the front ends and the rear ends of the two opposite edges thereof and respectively disposed next to the hooking ears 201. Each of the first sliding member 21 and the second sliding member 22 has two insertion holes 212, 222 respectively disposed at the front end and the rear end thereof and respectively disposed next to the holding blocks 211, 221. The insertion tabs 202 respectively insert into the insertion holes 212, 222. Thereby, the first sliding member 21 and the second sliding member 22 are respectively hooked on the two opposite edges of the connection plate 20 and form a card insertion space 204 therebetween. The first sliding member 21 and the second sliding member 22 are between the front baffle 102 and the rear baffle 103 of the first sidewall 11 and the front baffle 102 and the rear baffle 103 of the second sidewall 12, respectively. The card insertion space 204 is between the base plate 10 of the insulating housing 1 and the connection plate 20, and the electronic card is inserted into the card insertion space 204. The connections between the first sliding member 21, the second sliding member 22, and the connection plate 20 form a gap, for easy insertion of different electronic cards into the card insertion space 204. Further, the connection plate 20 defines a plurality of positioning holes 203, and each of the first sliding member 21 and the second sliding member 22 has a plurality of positioning blocks 213, 223. The positioning blocks 213, 223 are respectively located in the positioning holes 203. Thereby, the assembly of the connection plate 20, the first sliding member 21, and the second sliding member 22 is much simpler, and the sliding assembly 23 remains stable when an electronic card is inserted therein. Each of the first sliding member 21 and the second sliding member 22 respectively has a guiding block 214, 224 disposed at a bottom thereof. The guiding blocks 214, 224 are respectively and slidably arranged in the guiding slots 105 of the base plate 10 of the insulating housing 1. The first sliding member 21 has a first push portion 215 disposed at a front edge thereof, and the second sliding member 22 has a second push portion 225 disposed at a front edge thereof. The first push portion 215 and the second push portion 225 extend into the card insertion space 204 for being pushed by two corners of a front edge of the electronic card when being inserted into the sliding space 101 of the insulating housing 1 and for pushing the two corners of the front edge of the electronic card to eject it out of the sliding space 101. The connection plate 20 further has a resilient arm 205 disposed at a front edge thereof. The first sliding member 21 further has a recess 216 at a front edge thereof. The resilient arm 205 is received in the recess 216 and has a free end extending outwardly to a front of the recess 216 to hook in a positioning hole at a lateral side of the electronic card, such as a positioning hole of an XD (eXtreme Digital) card. Each of the first sliding member 21 and the second sliding member 22 defines a receiving hole 217, 227 at a rear end thereof. Each of the resilient members 25 has an end receiving in the receiving holes 217, 227, respectively, and another end abutting against the rear baffles 103 of the first sidewall 11 and the second sidewall 12 of the insulating housing 1, respectively. The rear baffle 103 of the first sidewall 11 has a pivot hole 106. The first sliding member 21 has a track slot 218 disposed at the rear end thereof. The guiding rod 24 defines a pivot end 241 and a guiding end 242 at two ends thereof. The pivot end 241 is pivotly connected in the pivot hole 106, and the guiding end 242 is movably installed in the track slot 218.

The first set of terminals 31 is assembled outside the base plate 10 of the insulating housing 1.

The second set of terminals 32 is assembled inside the base plate 10 of the insulating housing 1.

The third set of terminals 33 is assembled on a rear end of the insulating housing 1.

The first pressing plate 41 is fixed outside the base plate 10 and positions the first set of terminals 31.

The second pressing plate 42 is fixed inside the base plate 10 and positions the second set of terminals 32.

The rear pressing plate 43 has two protruding tabs 431 at an end thereof and another two protruding tabs 431 at another end thereof. The protruding tabs 431 are respectively clipped in the holding slots 104 of the first sidewall 11 and the second sidewall 12 of the insulating housing 1. The rear pressing plate 43 presses against a soldering portion of each of terminals of the first set of terminals 31, the second set of terminals 32, and the third set of terminals 33 to solder the terminals on a printed circuit board (not shown).

The cover 5 has a plurality of assembling pieces 50, an abutting piece 51, a downward projecting point 52, and two pressing pieces 53. Each of the first sidewall 11 and the second sidewall 12 of the insulating housing 1 has a plurality of assembling holes 107. The assembling pieces 50 respectively assemble into the assembling holes 107. Thereby, the cover 5 is assembled on the first sidewall 11 and the second sidewall 12 of the insulating housing 1. The sliding space 101 is between the cover 5 and the base plate 10. The abutting piece 51 abuts against the guiding rod 24 of the card ejection mechanism 2, and the downward projecting point 52 abuts against the pivot end 241 of the guiding rod 24 of the card ejection mechanism 2. The two pressing pieces 53 press against the third set of terminals 33.

The shielding casing 6 has a hooking arm 60 and a plurality of holding holes 61. Each of the first sidewall 11 and the second sidewall 12 of the insulating housing 1 respectively has a hooking portion 108 and a plurality of protrusions 109. The hooking arm 60 hooks on the hooking portion 108 of the first sidewall 11, and the protrusions 109 are respectively retained in the holding holes 61. Thereby, the shielding casing 6 is assembled on the first sidewall 11 and the second sidewall 12 of the insulating housing 1 and is outside the first pressing plate 41.

When an electronic card is inserted into the card insertion space 204, two corners of a front edge of the electronic card push the first push portion 215 of the first sliding member 21 and the second push portion 225 of the second sliding member 22 of the sliding assembly 23, respectively, so that the sliding assembly 23 slides toward the rear end of the insulating housing 1. Because the guiding end 242 of the guiding rod 24 of the card ejection mechanism 2 moves in the track slot 218, the electronic card is inserted and positioned in the sliding space 101 of the insulating housing 1 and electrically contacts the first set of terminals 31, the second set of terminals 32, or the third set of terminals 33. When the electronic card is pushed into the insulating housing 1 again, because the guiding end 242 of the guiding rod 24 moves in the track slot 218, and because the two resilient members 25 generate elasticity, the first push portion 215 of the first sliding member 21 and the second push portion 225 of the second sliding member 22 push the two corners of the front edge of the electronic card, respectively, so that the electronic card is ejected from the sliding space 101. As the first sliding member 21 and the second sliding member 22 are respectively hooked on two opposite edges of the connection plate 20, the structure of the sliding assembly 23 is much more balanced; the action of the card ejection mechanism 2 is thus much more stable. Additionally, the first sliding member 21 and the second sliding member 22 are not deformed easily, and the action of the guiding end 242 of the guiding rod 24 is thus much smoother. Furthermore, when the electronic card is inserted into or ejected from the insulating housing 1, the acting force between the sliding assembly 23 and the electronic card is much more balanced, so that he insertion and ejection of the electronic card is much smoother.

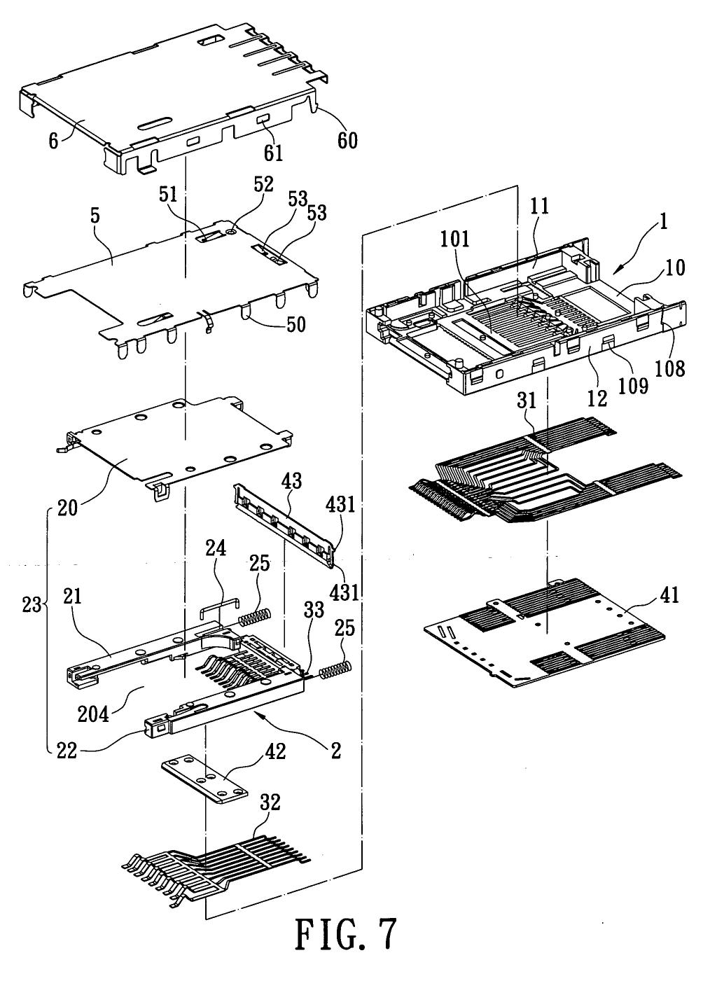

FIG. 7 shows another embodiment of the card reading apparatus of the present invention. In this embodiment, a bending direction of a soldering portion of each of terminals of the first set of terminals 31, the second set of terminals 32, and the third set of terminals 33 is different from that of the soldering portion in the previous embodiment, so as to provide more design flexibility for soldering the terminals on a printed circuit board.

As indicated above, the card reading apparatus of the present invention has the following advantages:

(1) The first sliding member and the second sliding member are respectively hooked on two opposite edges of the connection plate, so that the structure of the sliding assembly is much more balanced, so that the action of the card ejection mechanism is much more stable. Furthermore, when the electronic card is inserted into or ejected from the insulating housing, the acting force between the sliding assembly and the electronic card is much more balanced, so that the insertion or the ejection of the electronic card is much smoother.

(2) The holding blocks and the insertion holes of the first sliding member and the second sliding member respectively assemble with the hooking ears and the insertion tabs disposed at the two opposite edges of the connection plate and respectively form a gap therebetween, so that different electronic cards are easily inserted into the card insertion space. Furthermore, the positioning blocks of the first sliding member and the second sliding member respectively position in the positioning holes of the connection plate, so that the assembly of the card reading apparatus is much simpler and the use of the card reading apparatus is stable.

(3) The resilient arm of the connection plate hooks in the positioning hole of the electronic card, so that the insertion of the electronic card is more stable.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A card reading apparatus for insertion of an electronic card therein, the card reading apparatus comprising:
an insulating housing comprising a sliding space formed therein; and
a card ejection mechanism including a sliding assembly, the sliding assembly being slidably arranged in the sliding space and including a connection plate, a first sliding member and a second sliding member, the first sliding member and the second sliding member being respectively hooked on two opposite edges of the connection plate and forming a card insertion space therebetween, and the electronic card being inserted into the card insertion space.

2. The card reading apparatus as claimed in claim 1, wherein the connection plate of the sliding assembly has four hooking ears respectively disposed at a front end and a rear end of the two opposite edges, the first sliding member of the sliding assembly has two holding blocks respectively disposed at a front end and a rear end thereof, and the second sliding member of the sliding assembly has two holding blocks respectively disposed at a front end and a rear end thereof, and wherein the holding blocks are respectively hooked in the hooking ears.

3. The card reading apparatus as claimed in claim 2, wherein the connection plate of the sliding assembly has four insertion tabs respectively disposed at the front ends and the rear ends of the two opposite edges and respectively disposed next to the hooking ears, and each of the first sliding member and the second sliding member of the sliding assembly has two insertion holes respectively disposed at the front end and the rear end thereof and respectively disposed next to the holding blocks, and wherein the insertion tabs respectively insert into the insertion holes.

4. The card reading apparatus as claimed in claim 1, wherein the connection plate of the sliding assembly defines a plurality of positioning holes, and each of the first sliding member and the second sliding member of the sliding assembly has a plurality of positioning blocks, and wherein the positioning blocks are respectively located in the positioning holes.

5. The card reading apparatus as claimed in claim 1, wherein the connection plate of the sliding assembly further has a resilient arm disposed at a front edge thereof, and the first sliding member of the sliding assembly further has a recess at a front edge thereof, and wherein the resilient arm receives in the recess and has a free end extending outwardly to a front of the recess.

6. The card reading apparatus as claimed in claim 1, wherein the first sliding member of the sliding assembly has a first push portion disposed at a front edge thereof, and the second sliding member of the sliding assembly has a second push portion disposed at a front edge thereof, and wherein the first push portion and the second push portion extend into the card insertion space.

7. The card reading apparatus as claimed in claim 1, wherein the insulating housing has a base plate, a first sidewall, and a second sidewall, the first sidewall and the second sidewall respectively connecting on two opposite edges of the base plate to form the sliding space of the insulating housing therebetween, and the card insertion space being between the base plate and the connection plate of the sliding assembly.

8. The card reading apparatus as claimed in claim 7, further comprising a cover, the cover being assembled on the first sidewall and the second sidewall of the insulating housing, the sliding space being between the cover and the base plate, the first sidewall and the second sidewall respectively having a front baffle at a front end thereof, the first sidewall and the second sidewall respectively having a rear baffle at a rear end thereof, and the first sliding member and the second sliding member being between the front baffle and the rear baffle of the first sidewall and the front baffle and the rear baffle of the second sidewall, respectively.

9. The card reading apparatus as claimed in claim 8, wherein the card ejection mechanism includes a guiding rod and two resilient members, and each of the first sliding member and the second sliding member defmes a receiving hole at a rear end thereof, wherein each of the resilient members has an end received in the receiving holes, respectively, and another end abutting against the rear baffles of the first sidewall and the second sidewall, respectively, wherein the rear baffle of the first sidewall has a pivot hole, the first sliding member has a track slot disposed at the rear end thereof, and the guiding rod defines a pivot end and a guiding end at two ends thereof, and wherein the pivot end is pivotly connected in the pivot hole, and the guiding end is movably installed in the track slot.

10. The card reading apparatus as claimed in claim 9, wherein each of the first sidewall and the second sidewall of the insulating housing has a plurality of assembling holes, and the cover has a plurality of assembling pieces, an abutting piece, and a downward projecting point, and wherein the assembling pieces respectively assemble into the assembling holes, the abutting piece abuts against the guiding rod, and the downward projecting point abuts against the pivot end of the guiding rod.

11. The card reading apparatus as claimed in claim 8, further comprising a first set of terminals, a second set of terminals, a third set of terminals, a first pressing plate, a second pressing plate, and a rear pressing plate, the first set of terminals being assembled outside the base plate of the insulating housing, the first pressing plate being fixed outside the base plate and positioning the first set of terminals, the second set of terminals being assembled inside the base plate of the insulating housing, the second pressing plate being fixed inside the base plate and positioning the second set of terminals, the third set of terminals being assembled on a rear end of the insulating housing, the cover having two pressing pieces, the two pressing pieces pressing against the third set of terminals, each of the first sidewall and the second sidewall of the insulating housing having two holding slots disposed at the rear ends thereof, the rear pressing plate having two protruding tabs at an end thereof and another two protruding tabs at another end thereof, the protruding tabs being respectively clipped in the holding slots, and the rear pressings plate pressing against a soldering portion of each of terminals of the first set of terminals, the second set of terminals, and the third set of terminals.

12. The card reading apparatus as claimed in claim 7, further comprising a shielding casing, the shielding casing having a hooking arm and a plurality of holding holes, and each of the first sidewall and the second sidewall of the insulating housing respectively having a hooking portion and a plurality of protrusions, wherein the hooking arm hooks on the hooking portion of the first sidewall and the protrusions are respectively retained in the holding holes.

13. The card reading apparatus as claimed in claim 7, wherein the base plate of the insulating housing has two guiding slots respectively disposed at the two opposite edges thereof, and each of the first sliding member and the second sliding member respectively has a guiding block disposed at a bottom thereof, wherein the guiding blocks are respectively and slidably arranged in the guiding slots.
